(19) United States
(12) Patent Application Publication
(10) Pub. No.: US 2023/0114110 A1
(43) Pub. Date: Apr. 13, 2023

(54) Standby Solution For Extended Run Time Power Systems

(71) Applicant: Advanced Powering Services, Inc., Rancho Santa Margarita, CA (US)

(72) Inventors: Timothy W. Scharf, Lake Forest, CA (US); Richard J. Bower, Trabuco Canyon, CA (US); Alfonso Alvizar, Tustin, CA (US)

(73) Assignee: Advanced Powering Services, Inc., Rancho Santa Margarita, CA (US)

(21) Appl. No.: 17/963,499

(22) Filed: Oct. 11, 2022

Related U.S. Application Data
(60) Provisional application No. 63/254,038, filed on Oct. 8, 2021.

(51) Int. Cl. H02J 9/06; H02J 7/00; H01M 10/44

(52) U.S. Cl. CPC H02J 9/061; H02J 7/0063; H02J 7/007182; H02J 7/00032; H02J 7/0047; H01M 10/44; H02J 2207/20; H01M 50/519

(57) ABSTRACT

A standby solution for extended run time power systems for a load at a telecom site with backup power includes an interface distribution module including a battery bus, a lithium battery electrically connected to the battery bus, a charging rectifier electrically connected to the interface distribution module. The standby solution has a line mode, wherein the charging rectifier maintains a constant maximum voltage level of the lithium battery, a discharge mode, wherein the interface distribution module engages a discharge bias to enable discharge of the lithium battery to the load, and a charge mode, wherein the interface distribution module disengages the discharge bias to disable discharge of the lithium battery.

### CROSS-REFERENCE TO RELATED APPLICATIONS

This application claims the benefit of U.S. Provisional Application No. 63/254,038, filed Oct. 8, 2021, which is hereby incorporated by reference in its entirety.

### FIELD

The present specification relates generally to electricity, and more particularly to backup electricity systems.

### BACKGROUND

Reliable telecommunications systems are vital to meet the needs of different stakeholders at all times. In emergency conditions, those needs become even more pronounced. For instance, members of the public in personal emergency situations need to be able to call and receive emergency help, and first responders must be able to call and coordinate with dispatch, headquarters and each other to fulfill emergency services.

Unfortunately, increasingly frequent and prolonged fires impact the reliability of telecommunications systems. Forest fires especially can cripple telecommunications networks if power to the network is reduced or eliminated. Some parts of the telecommunication network are more vulnerable than others. Telecommunication cabinets house critical infrastructure for supporting local telecom networks. A telecommunication cabinet destroyed by fire isolates everyone downstream from that cabinet. Residents may no longer receive evacuation warnings, fire fighters may be unable to organize clearance and rescue work, and anyone experiencing an emergency may not be able to request help.

Most telecommunication cabinets have backup power solutions that can provide short-term power to the network in the event that power delivered through the power line is removed. These backup power solutions typically rely on lead batteries to deliver DC power.

At some cabinets, a fuel-powered generator stores its own fuel, such as within a propane tank. Other cabinets have generators which use natural gas. When AC power fails, the generator auto-starts, burns the fuel, and provides power to the back-up batteries. These solutions require regular truck rolls to refill the propane or natural gas tanks. They also make noise when operating and present serious combustion or explosion risks. In some locations, local fire codes prevent the use of generators.

Moreover, prolonged outages exhaust the resources that conventional backup power solutions can provide. Discharge times can be relatively short and be insufficient to support telecommunications networks on which first responders and others rely. An improved way to power a telecommunications network—both during and long after a crisis event—is needed.

### SUMMARY

In an embodiment, a standby solution for extended run time power systems for a load at a telecom site with backup power includes an interface distribution module including a battery bus, a lithium battery electrically connected to the battery bus, a charging rectifier electrically connected to the interface distribution module. The standby solution has a line mode, wherein the charging rectifier maintains a constant maximum voltage level of the lithium battery, a discharge mode, wherein the interface distribution module engages a discharge bias to enable discharge of the lithium battery to the load, and a charge mode, wherein the interface distribution module disengages the discharge bias to disable discharge of the lithium battery.

In embodiments, the charging rectifier powers the battery bus. The charging rectifier powers the battery bus with electricity from an AC power line so that the lithium battery meets pre-determined current and voltage characteristics and then maintains the constant maximum voltage level of the lithium battery. The interface distribution module includes a power supply bus to which the backup power is electrically coupled, and a solid-state relay which combines the power supply bus and the battery bus in parallel to provide power to the load. When the standby solution is in the discharge mode, the solid-state relay combines the power supply bus and the battery bus to contemporaneously provide power to the load from both the lithium battery and the backup power. The lithium battery includes a battery out that is electrically coupled to the battery bus, battery cells, a battery power board electrically coupled to each of the battery cells and to the battery out, a battery monitoring system electrically coupled to each of the battery cells and coupled in data communication to the interface distribution module. The battery power board includes a MOSFET for engaging and disengaging the discharge bias in response to instructions from the interface distribution module in response to information from the battery monitoring system about a charge state of the battery cells.

In an embodiment, a standby solution for extended run time power systems for a load at a telecom site including a UPS, a backup battery, and an AC power line includes an interface distribution module including a battery bus and a power supply bus, wherein the UPS and the backup battery are electrically connected to the power supply bus. A lithium battery is electrically connected to the battery bus. A charging rectifier is electrically connected to the interface distribution module. The solution has a line mode, wherein the charging rectifier maintains a constant maximum voltage level of the lithium battery, a discharge mode, wherein the interface distribution module engages a discharge bias to enable discharge of the lithium battery to the load, and a charge mode, wherein the interface distribution module disengages the discharge bias to disable discharge of the lithium battery.

In embodiments, the charging rectifier powers the battery bus with electricity from the AC power line. The charging rectifier powers the battery bus with electricity from the AC power line so that the lithium battery meets pre-determined current and voltage characteristics and then maintains the constant maximum voltage level of the lithium battery. The interface distribution module includes a solid-state relay which combines the power supply bus and the battery bus in parallel to provide power to the load. When the standby solution is in the discharge mode, the solid-state relay combines the power supply bus and the battery bus to contemporaneously provide power to the load from both the lithium battery and the backup battery. The lithium battery includes a battery out that is electrically coupled to the battery bus, battery cells, a battery power board electrically coupled to each of the battery cells and to the battery out, and a battery monitoring system electrically coupled to each of the battery cells and coupled in data communication to the interface distribution module. The battery power board includes a MOSFET for engaging and disengaging the discharge bias in response to instructions from the interface distribution module, in response to information from the battery monitoring system about the battery cells.

In an embodiment of a method of providing extended run-time power to a load at a telecom site including a UPS, backup battery, and an AC power line, the method includes providing an interface distribution module including a battery bus and a power supply bus, electrically connecting the UPS and the backup battery to the power supply bus, providing a lithium battery and electrically connecting the lithium battery to the battery bus, and providing a charging rectifier electrically connected to the interface distribution module. During a line mode, the charging rectifier maintains a constant maximum voltage level of the lithium battery. During a discharge mode, the method engages a discharge bias to enable to discharge of the lithium battery to the load in parallel with the backup battery. During a charge mode, the method disengages the discharge bias to disable discharge of the lithium battery to the load.

In embodiments, the interface distribution module includes a solid-state relay which combines the power supply and the battery bus in parallel so that, during the discharge mode, the interface distribution module contemporaneously provides power to the load from both the lithium battery and the backup battery.

The method includes providing a sense line coupling the AC power line and the interface distribution module, so as to provide information about power on the AC power line, and the interface distribution module changing from the line mode to the discharge mode in response to the power on the AC power line dropping below a voltage threshold. The method includes continually providing power to the load during the line mode, during the discharge mode, and while the interface distribution module changes from the line mode to the discharge mode. The method includes providing a battery monitoring system electrically coupled to battery cells within the lithium battery and coupled in data communication to the interface distribution module, and during line mode, the charging rectifier receiving information about a charge state of the lithium battery from the battery monitoring system via the interface distribution module and making power available to the battery bus to feed power to the lithium battery. During the charge mode, the charging rectifier receives information from battery monitoring system so as to control charging of the battery cells evenly. During the discharge mode, if the battery monitoring system detects a discharge current from the lithium battery over a pre-determined threshold, the battery monitoring system instructs a battery power board to disengage the discharge bias to disable discharge of the lithium battery. If the battery monitoring system detects a charge of the lithium battery at or below a minimum charge threshold, the battery monitoring system instructs a battery power board to disengage the discharge bias to disable discharge of the lithium battery.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIG. 1 is a front perspective view of three cabinets housing a standby solution for an extended run time power system;

FIG. 2 is a front perspective view of the right-most cabinet of FIG. 1, housing part of the standby solution for the extended run time power system;

FIG. 3 is a generalized schematic of the standby solution for the extended run time power system;

FIG. 4 is a generalized schematic of a lithium battery in the standby solution for the extended run time power system; and

FIG. 5 is a generalized schematic of an interface distribution model in the standby solution for the extended run time power system.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

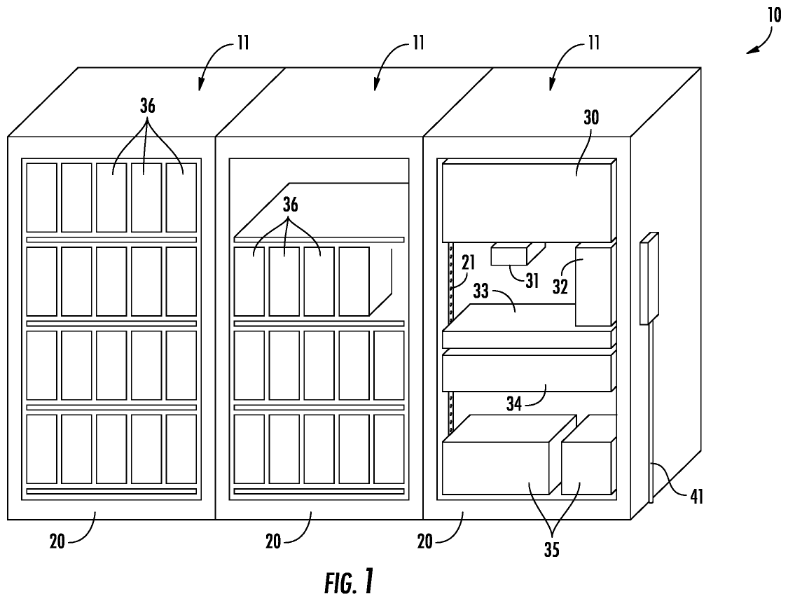

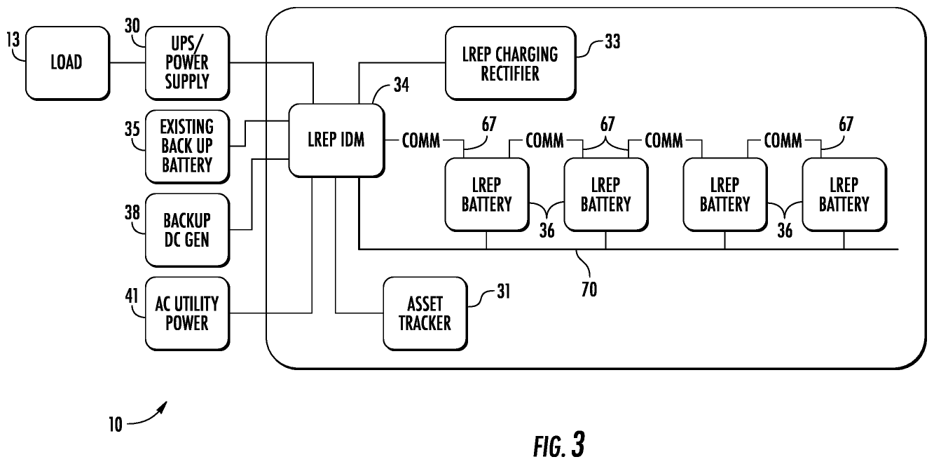

FIG. 1 is a perspective view of an embodiment of a cabinet installation including three side-by-side cabinets 11. The cabinets 11 typically have doors on their fronts; these cabinets 11 are shown without their doors so that the contents of the cabinets 11 are visible. The cabinets 11 house, protect from the environment, and are considered part of a standby solution for extended run time power system 10 (hereinafter, simply, the “standby solution 10”). The standby solution 10 provides backup power to a telecommunications network or system load 13 (shown in FIGS. 3-5). The standby solution 10 includes the cabinets 11, lithium batteries, an interface distribution model or “IDM”, and an asset tracker. These components interface with an existing uninterruptable power supply (“UPS”) and backup batteries, which components are also considered part of the standby solution 10.

The cabinets 11 are similar, though not necessarily identical. Each cabinet 11 includes an outer housing 20 constructed of a rugged, durable, and weather-proof material such as metal. The housing 20 protects the electrical and electronic components of the standby solution 10. Doors, not shown in FIG. 1, are fit to the housing 20, mounted on hinges for pivotal movement, and can be locked together or to the housing 20. The doors open to provide access to an interior of the cabinet 11.

The electrical and electronic components of the standby solution 10 are mounted within the interior of the cabinets 11. In some embodiments, only a single cabinet 11 is needed. In other embodiments, many cabinets 11 are needed. The number of cabinets needed is dictated primarily by the needs of the downline network: larger networks will typically require more cabinets 11. The components are preferably, but not necessarily, secured within the cabinet on the sides in a telecom rack 21. The cabinet 11 on the right side of FIG. 1 shows one side of the rack 21 and the components mounted thereto. In other embodiments, the cabinets 11 have shelves 22, which may be mounted for sliding movement into and out of the cabinet 11 to provide a technician more convenient access.

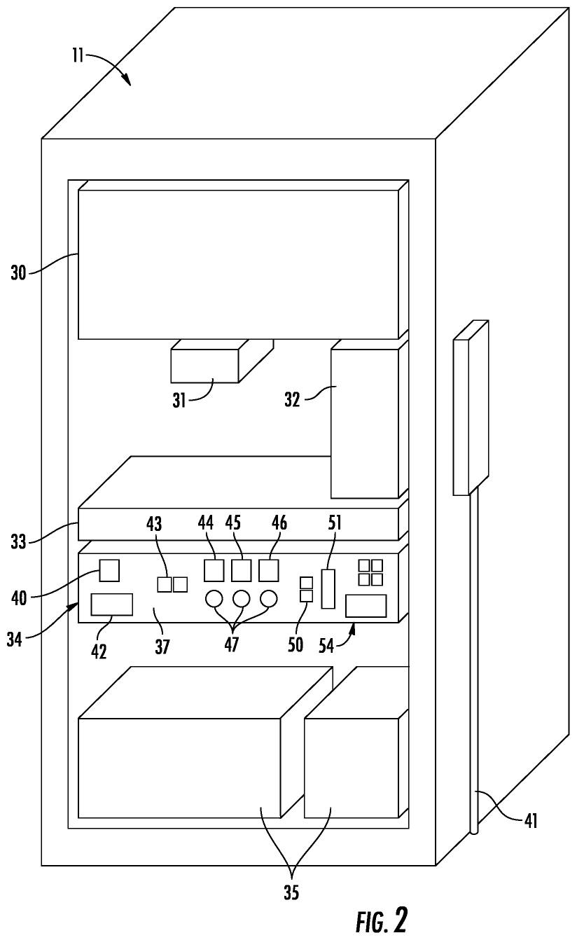

The cabinet 11 on the right in FIG. 1 is shown in greater detail in FIG. 2. That cabinet 11 houses a UPS 30, an asset tracker 31, a breaker panel 32, a charging rectifier 33, an IDM 34, and backup batteries 35. The IDM 34 couples with these components and has a front face 37 with a variety of ports and interfaces for doing so. In FIG. 2, the ports are shown as open and no cables are shown for the clarity of the illustration, but in use, most of the ports would receive cables coupling the IDM 34 to the respective components of the standby solution 10. For example, the front face 37 includes a port 40 for detecting power on an AC power line 41, a port 42 for a cable extending to the rectifier 33, and a port 43 for a cable extending to the lithium batteries 36 to couple the batteries 36 to the IDM 34 in data communication.

The front face 37 also includes ports 44, 45, and 46 for a cable extending to the asset tracker 31, for a cable extending to a BMS hub, and a CANBUS port allowing direct data communications between the IDM and a separate device. Below those three ports 44, 45, and 46, are three fuses 47. The front face 37 includes a port 50 for a cable extending to the backup batteries 35, a manual on-off switch 51, a port 52 for a cable extending to the UPS 30, and a port 53 for a cable to an external generator. Another port 54, on the back side of the IDM 34, is for a cable extending to the lithium batteries 36.

The IDM 34 receives and directs power to the network load. This power is supplied by the backup batteries 35 and the lithium batteries 36. If a generator is installed and running, the IDM 34 contemporaneously combines power from the generator with that provided by the batteries 35 and 36 to send to the load. The backup batteries 35 and generator are backup power for the UPS 30.

Returning to FIG. 1, the cabinets 11 in the middle and on the left in FIG. 1 house the lithium batteries 36. As noted above, the needs of the telecommunication network dictate the characteristics of the standby solution 10, which primarily determines the number of lithium battery 36 and thus the number of cabinets 11. FIG. 1 shows a non-limiting exemplary embodiment. In this example, there are thirty-four battery packs or seventeen lithium batteries 36 (two battery packs form one lithium battery 36). In other installations, there may be a lesser or greater number of batteries 36. Sites with lower power demands may only need a few lithium batteries 36, such as one, two, or three. Sites with larger power demands may need many lithium batteries 36, such as twenty or thirty. Cabinets 11 vary in size, and the lithium batteries 36 are compact such that they can be arranged in cabinets 11 differently to fill one cabinet before needing another cabinet 11. For example, larger cabinets 11 may be used or constructed but not necessarily filled with batteries 36; leaving room creates modularity in the system design, so that batteries 36 may be added in the future to increase the capacity of the standby solution 10.

Moreover, the terms “lithium battery 36” or “lithium batteries 36” are used primarily here, though occasionally this disclosure may also refer to just “battery 36” or “batteries 36.” However, this term is not limiting. The “lithium battery 36” or “battery 36” preferably identifies a lithium iron phosphate (LiFePO4) battery but also includes other reserve extended power batteries similar to these lithium reserve extended power (“LREP”) batteries, and this specification is intended to include such within its scope.

FIG. 3 illustrates the standby solution 10 as a generalized schematic, showing structural components thereof and the connections therebetween. FIG. 3 shows the IDM 34 at the center of the standby solution 10. The IDM includes connections to most of the other components in the standby solution 10.

FIG. 3 shows four lithium batteries 36. One having ordinary skill in the art will understand that these four lithium batteries 36 are shown for example and may be replaced by only a few lithium batteries 36 or by many lithium batteries 36. The lithium batteries 36 are all electrically connected to an electrical battery bus 70 which is coupled to the IDM 34. The lithium batteries 36 are connected in parallel. More lithium batteries 36 can be installed on the bus 70 to increase the capacity of the standby solution 10.

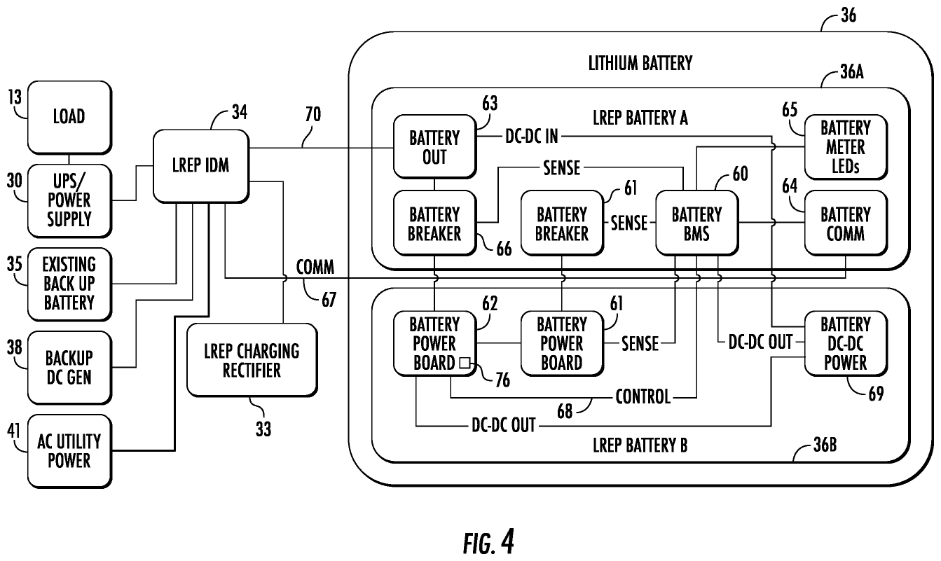

FIG. 4 illustrates a generalized schematic of a lithium battery 36 within the standby solution 10. Preferably, this battery has a rated capacity of 11 kW. In this embodiment, each lithium battery 36 is two battery packs. FIG. 4 shows those two battery packs as LREP Battery A and LREP Battery B, additionally marked with reference characters 36A and 36B, respectively. The battery packs 36A and 36B share a battery monitoring system or BMS 60, shown here on the battery pack 36A. The BMS 60 communicates with individual battery cells 61 in the battery 36 and controls and reports operating information about the battery cells 61 in both battery packs 36A and 36B.

Each battery cell 61 is a lithium battery having a casing with exposed anode and cathode ends. One or several battery cells 61 are included in each of the battery packs 36A and 36B, depending on the needs and design characteristics of the system. The battery cells 61 provides DC power, such that the battery 36 provides DC power.

A battery power board 62 is on the battery pack 36B. The battery cells 61 in both battery packs 36A and 36B are coupled directly to the battery power board 62; power from the battery cells 61 flows to the battery power board, which passes the power into a battery out port 63. The battery out port 63 is on the battery pack 36A, and is connected via a cable to the port 54 on the IDM 34. The port 54 on the IDM 34 connects directly to the battery bus 70, thereby connecting the battery pack 36 and the IDM 34 in electrical connection.

Power also passes through the battery power board 62 into the battery cells 61 when charging. The battery power board 62 is a circuit board including MOSFETs 76 that engage or disengage a charge and discharge bias to manage and control the current into and out of the battery 36, depending on the operating mode and the charge state of the battery cells 61. Those MOSFETs 76 have internal diodes that block current, thus controlling current bias into and out of the battery cells 61.

The battery power board 62 is also electrically connected directly to the BMS 60 via a control line 68 or signal. Along the control line 68, the BMS 60 receives information about the operating state of the battery cells 61 from the battery power board 62, and the BMS 60 controls charging of the battery cells 61 through the battery power board 62. Information sent to the BMS 60 via the battery power board 62 can then be passed on through a battery communication module 64 on the battery pack 36A to the IDM 34 via a comm line 67. And, similarly, the IDM 34 issues charging and discharging instructions to the BMS 60 through the communication module 64, and the BMS 60 in turn engages or disengages the MOSFETs 76 in the battery power board 62 to control charging and discharging. In this way, the battery 36 and the IDM 34 are coupled in data communication.

The BMS 60 in each lithium battery 36 is also connected, via the IDM 34, to the BMS 60 on each other lithium battery 36. This allows the BMS 60 in any one lithium battery 36 to compare its voltage with the voltage of all other lithium batteries 36. If, during operation, the BMS 60 for the lithium battery 36 detects that its voltage is different from the average voltage of other lithium batteries 36 by three volts, the BMS 60 instructs the battery power board 62 to disable the charge and discharge current bias until the voltage for the lithium battery 36 returns to within the plus/minus three volt threshold.

The BMS 60 can also display information on the lithium battery 36 itself. Battery pack 36A includes a set of LEDs 65 visible from outside the battery 36. The BMS is coupled in electrical communication with the LEDs 65 and instructs the LEDs 65 to light in different combinations and colors to display different types of information about the lithium battery 36. A technician can read these different combinations and colors of LEDs 65 to obtain information about the operating state of the lithium battery 36 without using the IDM 34.

Electrically coupled between the battery power board 62 and the battery out port 63 is a DC-DC power step-down module 69. The module 69 is also electrically connected to the BMS 60. The module 69 steps powers down to 12 volts to power the BMS 60 and other electronics in the battery 36, such as communication modules and the LEDs 65.

The lithium battery 36 also includes a battery breaker 66, shown here on battery pack 36A, to protect charging and discharging of the battery 36. The battery breaker is preferably a 75-Amp breaker which can shut off the positive line of the battery 36. If the battery 36 is overcharged, charged too quickly, discharged too quicky, or is in some other problematic state triggering that 75-Amp breaker, the battery breaker 66 will trip, disconnecting the battery 36 from the IDM 34.

Some of the components of the battery 36 are shown and have been described as being on one of the battery packs 36A or 36B. One having ordinary skill in the art will understand that such placement is not critical, and that those components may be located on the other of the battery packs 36A and 36B in any combination.

Returning to FIG. 3, the charging rectifier 33 is also coupled to the IDM 34. The charging rectifier 33 receives information about the charge state of each lithium battery 36 from the BMS 60 through the IDM. In turn, the charging rectifier 33 constantly makes power available to the battery bus 70, which feeds power to the batteries 36, such that the batteries 36 charge in parallel to meet pre-determined current and voltage characteristics. The rectifier 33 therefore controls charging of the battery cells 61. When the battery cells 61 are fully charged, as detected by the BMS 60, the BMS 60 communicates their voltages to the IDM, which in turn communicates this to the charging rectifier, which in turn maintains a constant voltage on the battery bus 70 to maintain the constant maximum voltage of the batteries 36. In other words, power is always available to the batteries 36 and if any need power, they can pull it from the battery bus 70 when needed.

The asset tracker 31 is coupled to the IDM. The asset tracker 31 is a data communication device. The asset tracker 31 includes a cellular antenna for communicating with an LTE network, receiving data from a central server, and transmitting data to the central server. The asset tracker 31 is coupled to the IDM 34 and to the BMS 60 for each battery 36 and receives operating information about the battery cells 61 from the BMSs 60 such as operating status, the percentage capacity of the battery cells 61, and other configurable information (such as whether the operating temperature of the battery cells 61 is above or below a configurable alarm limit). The asset tracker 31 receives power from the batteries 36 but also includes an internal battery as a backup if the battery cells 61 are fully discharged or disconnected. When it is receiving power, it can receive instructions through the LTE network and respond in kind. The asset tracker 31 includes a GPS chip, such that, if the IDM 34 is removed from the cabinet 11, the asset tracker 31 will transmit its location, as well as last operating information about the batteries 36 to a central server. This allows a central server owner to monitor the location and movement of the IDM 34. The asset tracker 31 transmits battery cell capacity levels, operating status, temperature information, GPS coordinates, and other information as configured by the owner of the central server.

The IDM 34 is electrically connected to the UPS 30, the backup batteries 35, a backup generator 38 if present, and the AC power line 41 supplied by the local utility. These components provide power to the load 13, the downline telecommunications network, before, during, and after emergencies. The IDM 34 combines power from each of these sources centrally and manages provision of power to the load 13.

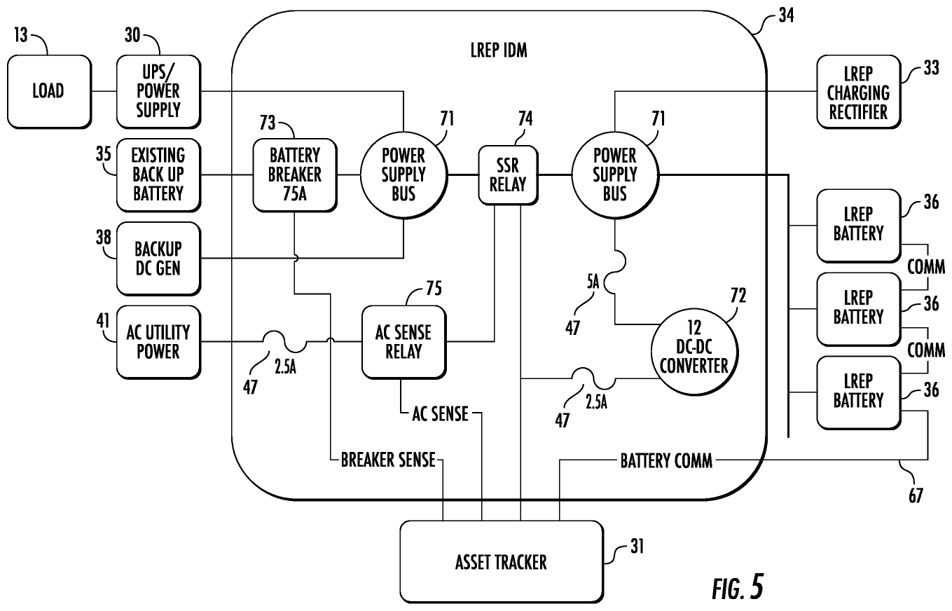

FIG. 5 shows a generalized schematic of the IDM 34, as it is connected, generally, between the batteries 36 and external power sources. The IDM includes a housing containing and protecting various electronic components for receiving power from various power sources, combining power from various power sources, transmitting power to the load, and controlling, monitoring, and reporting all of those activities. The housing, shown schematically in FIGS. 1 and 2, is sized and shaped to fit in a telecom rack so that it may be installed in a telecommunications cabinet 11 and mounted close to the UPS 30, backup batteries 35, and other equipment.

The IDM 34 includes the battery bus 70 and a power supply bus 71. As shown in FIG. 5, the battery bus 70 connects all lithium batteries 36 in the standby solution 10. All power to and from the batteries 36 is fed through the battery bus 70. The charging rectifier 33 is electrically coupled to the battery bus 70 to control voltage on the battery bus 70.

The battery bus 70 is also connected, via a DC-DC converter 72 which reduces voltage, to the asset tracker 31. This provides power to the asset tracker 31. The asset tracker 31 is also connected in data communication through the battery comm line 67 to each of the batteries 36. Two fuses 47 protect the asset tracker 31. One fuse 47, electrically connected between the battery bus 70 and the DC-DC converter 72, is rated for 5 Amps. The other fuse 47, electrically connected between the DC-DC converter 72 and the asset tracker 31, is rated for 2.5 Amps.

The IDM 34 also includes the power supply bus 71. The power supply bus 71 collects power from the various external power sources.

The UPS 30 is an uninterruptable power supply. It includes an inverter for converting AC power from the utility's AC power line 41 into DC power to the network load 13. The UPS 30 receives its backup power from the backup batteries 35. The backup batteries 35 are typically lead batteries. The number of lead batteries used in the standby solution 10 varies depending on the characteristics and needs of the load 13. A greater number of backup batteries 35 increases the capacity of the system and provides longer run times to the UPS 30 and the load 13.

Both the UPS 30 and the backup batteries 35 are electrically coupled to the power supply bus 71. The UPS 30 is directly coupled to the power supply bus 71, while the backup batteries are preferably connected to the power supply bus 71 by a battery breaker 73 rated at 75 Amps. With brief reference to FIG. 2, the UPS 30 electrically connects via cable to the port 52 on the front face 37 of the IDM 34, which then connects the UPS 30 electrically to the power supply bus 71. Similarly, the backup batteries 35 electrically connect via cable to the port 50 on the front face 37 of the IDM 34, which then connects the UPS 30 electrically to the power supply bus 71.

A portable backup DC generator 38 is also connected to the power supply bus 71. A backup DC generator 38, such as a gasoline generator is sometimes installed on site near the cabinet 11 and can provide power to the standby solution 10. The generator 38 electrically connects via cable to the port 53 on the front face 37 of the IDM 34, which connects to the power supply bus 71.

Power is fed to the IDM 34 via the battery bus 70 from the lithium batteries 36 and via the power supply bus 71 from the backup batteries 35 and DC generator 38. That power, in turn, is fed to the UPS 30 and then to the load 13. The power from these two busses 70 and 71 is combined at a solid-state relay 74. The solid-state relay 74 combines the two busses 70 and 71 in parallel. Within the solid-state relay 74, the negative sides of the busses 70 and 71 are bonded, and the positive sides of the busses 70 and 71 are separated by the relay 74. This ensures that, when the standby solution 10 is operating in discharge mode, the UPS 30 continually provides power to the load 13.

In operation, the standby solution 10 is normally in line mode. The standby solution 10 leaves standby and enters backup or discharge mode when the AC power line 41 fails. When this occurs, the standby solution 10 combines power from the various power sources to continue to supply power to the UPS 30.

In line mode, the AC power line 41 provides power to the UPS 30 and to the load 13. The AC power line 41 is installed by the local utility and provides AC power at 120 VAC. The AC power line 41 is electrically connected to the solid-state relay 74 and then to the power supply bus 71 for provision to the UPS 30. Power from the AC power line 41 also is sent to the battery bus 70 to ensure the lithium batteries 36 are maintained at full charge. The rectifier 33 is programmed to maintain current limits and target voltages of the lithium batteries 36. Once those targets are met, the rectifier 33 enters a constant voltage, maintaining voltage across the battery bus 70 to keep the lithium batteries 36 topped off. Nonetheless, power from the charging rectifier 33 is always available, and if any of the lithium batteries 36 need charging power, the battery 36 draws that power from the battery bus 70. The batteries 36 maintain this line mode until needed.

If the AC power line 41 fails, such as by dropping below a voltage threshold, the in response the IDM 34 places the standby solution 10 into the backup or discharge mode from the line mode. The IDM 34 combines the power from both the battery bus 70 and the power supply bus 71 to back up the load 13. A failure in the AC power line 41 occurs when there is no power whatsoever in the AC power line 41 or when the voltage is less than 80 VAC. A sense line 75 connects the AC power line 41 and the solid-state relay 74, as shown in FIG. 5, and the sense line 75 provides information about power on the AC power line 41 so that the IDM 34 preferably continually monitors the power on the AC power line 41. When the AC power line 41 fails, the IDM 34 enables combining of the two power busses 70 and 71 in parallel. Thus, the lithium batteries 36 concurrently deliver power to the UPS 30 with the backup batteries 35. If a DC generator 38 is connected to the IDM 34, then the IDM 34 also concurrently combines the power from the DC generator 38 as well.

The lithium batteries 36 are preferably able to provide power in discharge mode for at least 72 hours. When power is combined with the power from the backup batteries 35 and/or the DC generator 38, the run time in discharge mode is even longer.

During discharge mode, each battery power board 62 manages the current out of its lithium battery 36. If the BMS 60 for the battery 36 detects a discharge current over a predetermined threshold, the BMS 60 disable the discharge MOSFETs 76 on the battery power board 62 to disengage the discharge bias. After a delay, and if the threshold is no longer exceeded, the BMS 60 reengages the discharge MOSFETs 76, allowing the battery 36 to discharge and provide power to the battery bus 70.

The standby solution 10 provides power to the load 13 until the lithium batteries 36 are depleted. When a battery 36 reaches a minimum charge threshold, the BMS 60 for that battery will disable the discharge MOSFETs 76 so as to disengage the discharge current bias. A secondary threshold below the minimum charge threshold is set at a lower voltage; when the battery 36 reaches this secondary threshold, the BMS 60 completely disables the MOSFETs 76 and completely disengages the discharge bias. This protects the battery cells 61 from low-voltage damage.

When power returns along the AC power line 41, the IDM 34 detects this return of power along the sense line 75 and automatically places the standby solution 10 into the charge mode. Return of power occurs when the AC power line 41 operates at 120 VAC. In response, the IDM 34 isolates both the battery bus 70 and the power supply bus 71. The charging rectifier 33 starts up and begins feeding power from the AC power line 41 to the battery bus 70. Power along the battery bus 70 charges the lithium batteries 36.

The lithium batteries 36 charge in parallel from the battery bus 70. The BMS 60 for each lithium battery 36 balances the charge returning to each battery cell 61, so that the battery cells 61 charge substantially equally and evenly. The BMS 60 cuts off the charging current at a predetermined threshold or pack level for the battery 36. The BMS 60 thus acts as a safety monitor to protect the battery 36 from over charging.

At any time, whether during line mode, discharge mode, or charge mode, if the BMS 60 detects unsafe conditions, the BMS 60 disables the lithium battery 36 by instructing the battery power board to disable the current charge or discharge bias. Unsafe conditions include internal cell faults, temperatures above or below predetermined thresholds, loss of communication with the BMS 60, and other problematic conditions.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

### APPENDIX

Attached hereto and submitted herewith as a part of this application is an Appendix to the Specification, which includes further disclosure relevant to the Specification. The images enclosed herein (e.g., Appendix FIGS. A-G) depict particular embodiments of the standby solution for extended run time power systems described in the Specification. However, other embodiments exist, and those images do not and should not be construed to limit the construction, structure, operation, features, functions, appearance, placement, size or anything else related to the standby solution for extended run time power systems. The images in this Appendix depict other embodiments of the standby solution for extended run time power systems.

Applicant considers the invention as including the embodiments shown in FIGS. 1-5 and the images shown in this Appendix, and any and all parts, portions, elements, and/or combinations of any of the FIGS. 1-5 and the images of this Appendix. Applicant reserves the right to claim any part, portion, feature, element, and/or combination of any of the FIGS. 1-5 and the images of this Appendix. The applicant further reserves the right to create black-and-white line drawings from the images of this Appendix and, in doing so, show any part, portion, line, feature, element, or anything else shown in the images of this Appendix in solid line or broken line of any form.

Upon allowance, if authorized by Applicant, Examiner may delete this Appendix upon allowance, and only to the extent authorized by Applicant. The Appendix shall nonetheless remain part of the prosecution history but need not be printed as part of any patent issuing from this Specification. Applicant does not authorize Examiner to make any substantive amendments to this Specification unless explicitly authorized by Applicant. Applicant respectfully requests that Examiner contact Applicant if Examiner desires to make such amendments.

What is claimed is:

1. A standby solution for extended run time power systems for a load at a telecom site with backup power, the standby solution comprising:
an interface distribution module including a battery bus;
a lithium battery electrically connected to the battery bus;
a charging rectifier electrically connected to the interface distribution module;
a line mode, wherein the charging rectifier maintains a constant maximum voltage level of the lithium battery;
a discharge mode, wherein the interface distribution module engages a discharge bias to enable discharge of the lithium battery to the load; and
a charge mode, wherein the interface distribution module disengages the discharge bias to disable discharge of the lithium battery.

2. The standby solution of claim 1, wherein the charging rectifier powers the battery bus.

3. The standby solution of claim 1, wherein the charging rectifier powers the battery bus with electricity from an AC power line so that the lithium battery meets pre-determined current and voltage characteristics and then maintains the constant maximum voltage level of the lithium battery.

4. The standby solution of claim 1, wherein the interface distribution module comprises:
a power supply bus to which the backup power is electrically coupled; and
a solid-state relay which combines the power supply bus and the battery bus in parallel to provide power to the load.

5. The standby solution of claim 4, wherein, when the standby solution is in the discharge mode, the solid-state relay combines the power supply bus and the battery bus to contemporaneously provide power to the load from both the lithium battery and the backup power.

6. The standby solution of claim 4, wherein the lithium battery comprises:
a battery out that is electrically coupled to the battery bus;
battery cells;
a battery power board electrically coupled to each of the battery cells and to the battery out; and
a battery monitoring system electrically coupled to each of the battery cells and coupled in data communication to the interface distribution module;
wherein the battery power board includes a MOSFET for engaging and disengaging the discharge bias in response to instructions from the interface distribution module in response to information from the battery monitoring system about a charge state of the battery cells.

7. A standby solution for extended run time power systems for a load at a telecom site including a UPS, a backup battery, and an AC power line, the standby solution comprising:
an interface distribution module including a battery bus and a power supply bus, wherein the UPS and the backup battery are electrically connected to the power supply bus;
a lithium battery electrically connected to the battery bus;
a charging rectifier electrically connected to the interface distribution module;
a line mode, wherein the charging rectifier maintains a constant maximum voltage level of the lithium battery;
a discharge mode, wherein the interface distribution module engages a discharge bias to enable discharge of the lithium battery to the load; and
a charge mode, wherein the interface distribution module disengages the discharge bias to disable discharge of the lithium battery.

8. The standby solution of claim 7, wherein the charging rectifier powers the battery bus with electricity from the AC power line.

9. The standby solution of claim 7, wherein the charging rectifier powers the battery bus with electricity from the AC power line so that the lithium battery meets pre-determined current and voltage characteristics and then maintains the constant maximum voltage level of the lithium battery.

10. The standby solution of claim 7, wherein the interface distribution module comprises a solid-state relay which combines the power supply bus and the battery bus in parallel to provide power to the load.

11. The standby solution of claim 10, wherein, when the standby solution is in the discharge mode, the solid-state relay combines the power supply bus and the battery bus to contemporaneously provide power to the load from both the lithium battery and the backup battery.

12. The standby solution of claim 10, wherein the lithium battery comprises:
a battery out that is electrically coupled to the battery bus;
battery cells;
a battery power board electrically coupled to each of the battery cells and to the battery out; and
a battery monitoring system electrically coupled to each of the battery cells and coupled in data communication to the interface distribution module;
wherein the battery power board includes a MOSFET for engaging and disengaging the discharge bias in response to instructions from the interface distribution module, in response to information from the battery monitoring system about the battery cells.

13. A method of providing extended run-time power to a load at a telecom site including a UPS, backup battery, and an AC power line, the method comprising:
providing an interface distribution module including a battery bus and a power supply bus;
electrically connecting the UPS and the backup battery to the power supply bus;
providing a lithium battery and electrically connecting the lithium battery to the battery bus;
providing a charging rectifier electrically connected to the interface distribution module;
during a line mode, the charging rectifier maintaining a constant maximum voltage level of the lithium battery;
during a discharge mode, engaging a discharge bias to enable to discharge of the lithium battery to the load in parallel with the backup battery; and
during a charge mode, disengaging the discharge bias to disable discharge of the lithium battery to the load.

14. The method of claim 13, wherein the interface distribution module includes a solid-state relay which combines the power supply and the battery bus in parallel so that, during the discharge mode, the interface distribution module contemporaneously provides power to the load from both the lithium battery and the backup battery.

15. The method of claim 13, further comprising:
providing a sense line coupling the AC power line and the interface distribution module, so as to provide information about power on the AC power line; and
the interface distribution module changing from the line mode to the discharge mode in response to the power on the AC power line dropping below a voltage threshold.

16. The method of claim 15, further comprising continually providing power to the load during the line mode, during the discharge mode, and while the interface distribution module changes from the line mode to the discharge mode.

17. The method of claim 13, further comprising:
providing a battery monitoring system electrically coupled to battery cells within the lithium battery and coupled in data communication to the interface distribution module; and
during line mode, the charging rectifier receiving information about a charge state of the lithium battery from the battery monitoring system via the interface distribution module and making power available to the battery bus to feed power to the lithium battery.

18. The method of claim 17, wherein, during the charge mode, the charging rectifier receiving information from battery monitoring system so as to control charging of the battery cells evenly.

19. The method of claim 17, wherein during the discharge mode, if the battery monitoring system detects a discharge current from the lithium battery over a pre-determined threshold, the battery monitoring system instructs a battery power board to disengage the discharge bias to disable discharge of the lithium battery.

20. The method of claim 17, wherein, if the battery monitoring system detects a charge of the lithium battery at or below a minimum charge threshold, the battery monitoring system instructs a battery power board to disengage the discharge bias to disable discharge of the lithium battery.
